(19) United States
(12) Patent Application Publication
(10) Pub. No.: US 2010/0003105 A1
(43) Pub. Date: Jan. 7, 2010

(54) METHOD FOR PRODUCING A LOCKING RING BOLT AND LOCKING RING BOLT

(75) Inventor: Ruediger Timmermann, Wiesbaden (DE)

Correspondence Address: GREENBLUM & BERNSTEIN, P.L.C., 1950 ROLAND CLARKE PLACE, RESTON, VA, 20191, US

(73) Assignee: GESIPA Blindniettechnik GmbH, Frankfurt a.M. (DE)

(21) Appl. No.: 12/239,337

(22) Filed: Sep. 26, 2008

(30) Foreign Application Priority Data
Sep. 29, 2007 (DE) 10 2007 046 788

(51) Int. Cl. F16B 39/28; F16B 39/24; B21H 3/02

(52) U.S. Cl. 411/133; 411/136; 470/12

(57) ABSTRACT

Method for producing a locking ring bolt, a locking ring bolt, and a fastening device. The method includes pressing a holding geometry into a stationary blank. The locking ring bolt includes a shank having a holding geometry that includes radially peripheral grooves interrupted by at least one web. The fastening device includes a shank having a holding geometry that includes at least one radially peripheral groove interrupted by at least one web, and a locking ring comprising a sleeve shaped body defining an interior.

### CROSS-REFERENCE TO RELATED APPLICATIONS

The present application claims priority under 35 U.S.C. §119 of German Patent Application No. 10 2007 046 788.7 filed Sep. 29, 2007, the disclosure of which is expressly incorporated by reference herein in its entirety.

### BACKGROUND OF THE INVENTION

1. Field of the Invention

The invention relates to a method for producing a locking ring bolt that has a holding geometry. Furthermore, the invention relates to a locking ring bolt with a shank that has a holding geometry that is embodied as radially peripheral grooves.

2. Discussion of Background Information

Locking ring bolts serve in connection with locking rings as two-part fastening elements for high-strength connections on pre-punched workpieces. The combination of locking ring bolt and locking ring is also referred to in general as a locking ring bolt system. With locking ring bolt systems, pre-stressed and vibration-proof connections can be realized.

The production of a connection with a locking ring bolt system begins with the insertion of the locking ring bolt into an opening in the workpiece. A bolt head of the locking ring bolt then bears against a surface of the workpiece. Subsequently the locking ring is guided over the locking ring bolt from the other side of the workpiece. Then a corresponding processing device is used to pull on the locking ring bolt, a tip of the processing device being placed over the locking ring and the locking ring being plastically deformed thereby such that it forms a positive connection with the holding geometry of the locking ring bolt. Through the pulling on the locking ring bolt the locking ring bolt is elastically expanded and a pre-stressing force is thus exerted on the workpiece. When a predetermined tensile force is reached, the locking ring bolt breaks at a predetermined breaking point, and the setting device can be removed. The setting operation is thereby completed.

Locking ring bolts must absorb high shearing stresses and tensile stresses. They are therefore generally produced in multi-stage processes having the steps of cold deformation, rolling, heat treatment and subsequent surface treatment. In cold deformation the outer rough shape of the locking ring bolt is produced, while the holding geometry is embossed by rollers. The holding geometry must be able to absorb high tensile forces and the breaking-point load must be defined within narrow limits so that a heat treatment of the locking ring bolt is necessary following the rolling. A production method of this type is complex and therefore cost-intensive.

### SUMMARY OF THE INVENTION

According to embodiments of the invention, the expenditure necessary for the production of the locking ring bolt can be kept low.

According to embodiments of the invention, a method for forming a locking ring bolt can include that the holding geometry is pressed into a stationary blank.

Through the pressing-in of the holding geometry, a cold-work hardening of the blank or of the holding geometry occurs that is so strong that a subsequent heat treatment can be omitted completely. The process speed also increases thereby compared to rolling, since the complete holding geometry is inserted in one step, rather than shaped gradually, as in rolling. The holding geometry is no longer limited to rotating shapings thereby either, but can be embodied in a variable manner.

Preferably the blank is separated from a wire. This can take place at the same time as the pressing-in of the holding geometry as well as already at an earlier point. A wire can be ordered in the desired diameter relatively cost-effectively directly from the wire manufacturer. The wire has a strength that allows the generation of a defined breaking load of the bolt through a defined predetermined breaking point symmetry.

A predetermined breaking point is preferably pressed in. The rupture force necessary at the conclusion of the setting operation can be adjusted with a predetermined breaking point. At the same time, the point is also defined at which the locking ring bolt will rupture. The pressing-in of the predetermined breaking point thereby represents a simple possibility for introducing a reduction in diameter of the locking ring bolt. It is also possible to press the predetermined breaking point into the blank at the same time as the holding geometry.

Preferably, a bolt head is pressed on at one end of the blank. The blank can thereby first have a constant diameter over its entire length. The increase in diameter in the area of the bolt head, which is required for placement on a workpiece, is thereby produced by the flow processes occurring during the pressing.

Preferably, an at least two-part mold is used for the pressing. With a two-part mold, the two parts of the mold are pressed against the blank and thus generate the desired shaping. A two-part mold can thereby be produced relatively cheaply as a rule.

In a preferred embodiment, the pressing-in of the holding geometry, the predetermined breaking point and the bolt head occurs simultaneously with or after the separation of the blank. The shaping of the locking ring bolt from a wire can therefore take place in one step with the separation of the blank from the wire. Very little time is needed for the shaping of the locking ring bolt through the simultaneous performance of several shaping steps. A high process speed can thus be realized.

Preferably, a point is formed on the end of the blank facing away from the bolt head. This point makes it easier to insert the bolt head into the opening of the workpieces, as well as to slip over the locking ring and to place the setting device. It is conceivable thereby for the point to be shaped at the same time as the pressing-in of the holding geometry or to be produced directly when the wire is cut off by a special measurement geometry.

Preferably, the holding geometry is embodied as radially peripheral grooves, the grooves being interrupted by at least one web running perpendicular to the grooves. Peripheral grooves offer a good surface for a positive connection to the locking ring that is shaped in these grooves during the setting operation. Through the pressing of the holding geometry it is not possible anyway to emboss the grooves into the locking ring bolt completely symmetrically, since a lower deformation occurs in the area of the connection points between the individual parts of the mold. This is now utilized to insert a web that interrupts the peripheral grooves. This web then serves as an anti-rotation element for the locking ring and reduces the forming forces necessary for shaping the locking ring.

It is particularly preferable that at least one torque working surface is shaped into the bolt head. A torque can be applied to the locking ring bolt with a corresponding tool via this torque working surface. Through a twisting of the locking ring bolt with respect to the locking ring a new expansion of the locking ring occurs due to the web so that the connection can be released.

With a preferred embodiment, a heat treatment takes place after the pressing. This final heat treatment serves to further increase the strength of the locking ring bolt. If necessary, an additional surface treatment, for example an electroplating surface treatment, of the locking ring bolt can also take place.

According to embodiments of the invention, a locking ring bolt can include grooves that are interrupted by at least one web.

It is thus possible to press in the holding geometry and thus to omit a complex rolling with subsequent heat treatment. Furthermore, the web serves as an anti-rotation element for the locking ring and reduces the forming forces necessary for shaping the locking ring.

It is particularly preferred thereby for the web to extend perpendicular to the grooves. This facilitates the embodiment of the molds, since the web can then be produced simply along a straight connection plane between the parts of the mold.

Preferably, the locking ring bolt has a bolt head and a point that are arranged on opposite ends of the shank, whereby the grooves are arranged over the entire shank between bolt head and point. The bolt head thereby serves as the later abutting piece on the workpiece, the point serves easier insertion of the locking ring bolt into the openings of the workpiece, easier slipping-on of the locking ring and simpler placing of the setting tool. If the grooves are now arranged over the entire shank between bolt head and point, the locking ring bolt can be used in connection with different thicknesses of the workpieces to be connected. It is even conceivable thereby for the locking ring to be shaped only in the grooves connecting to the point. The setting of the locking ring then takes place without tensile force being exerted on the locking ring bolt.

Preferably, a predetermined breaking point is arranged between the grooves and the point. This predetermined breaking point serves to define the necessary rupture force at the end of the setting operation and at the same time to establish the point at which the locking ring bolt ruptures.

Preferably, the predetermined breaking point has a polygonal, in particular square, cross section. A cross section of this type can be produced easily by pressing. The expenditure for inserting the predetermined breaking point is therefore kept low.

With a preferred embodiment of this type, holding grooves are arranged between the predetermined breaking point and the point. These holding grooves are used for better transfer of force between the setting tool and the locking ring bolt during the setting operation. Higher tensile forces can thus be transferred.

Preferably, the bolt head has at least one torque working surface. It is thus possible to apply a torque to the locking ring bolt. Through a twisting of the locking ring bolt relative to the locking ring, the locking ring is expanded again due to the web so that the locking ring can be more easily removed.

Preferably, the transition from the bolt head to the shank is step-shaped. The transition from the larger diameter of the bolt head to the smaller diameter of the shank is therefore not made in one stage, but has at least one step. Through a corresponding selection of the diameter of this step it is pulled into the opening of the workpiece during the setting of the locking ring bolt so that a press fit forms between the locking ring bolt and the workpiece. The strength of the connection produced is thus increased.

Preferably, the transition from the bolt head to the shank is continuous. The easy drawing-in of the bolt head into the opening of the workpiece is thus promoted and a press connection is thus formed between the locking ring bolt and the workpiece. The locking ring bolt can thereby also be used in the case of slightly different sizes of the openings in the workpiece.

Preferably, the grooves have a cross section in the shape of a circle segment. A groove cross section of this type promotes the flowing-in of the locking ring during the setting operation. Due to the symmetrical embodiment of the grooves, the molds can thereby also be produced with low expenditure.

In a preferred exemplary embodiment the grooves have a trapezoidal cross section. A trapezoidal cross section renders possible a gearing of the shaped locking ring with the grooves of the locking ring bolt and thus a high-strength connection.

It is particularly preferred thereby that one side of the respective groove that lies closer to the bolt head has a shallower angle to the circumferential surface of the shank than a more distant side. The more distant side of the respective groove serves to transfer the essential part of the holding forces between the locking ring and the locking ring bolt. These holding forces are tensile forces that act in the longitudinal direction of the locking ring bolt, i.e., also parallel to the circumferential surface of the shank. A side arranged at a steep angle to the circumferential surface therefore renders possible a good transfer of force. No forces need to be transferred via the groove lying closer to the bolt head. This groove can therefore have a shallow angle to the circumferential surface, which reduces the forming forces necessary for shaping the locking ring.

Preferably, the locking ring bolt is provided with a locking ring that surrounds an interior in a sleeve-shaped manner. The locking ring bolt can thereby fill the interior of the locking ring virtually completely. The locking ring is finally shaped with the aid of the setting tool, the material of the locking ring flowing partially into the holding geometry of the locking ring bolt.

It is particularly favorable thereby that the holding geometry of the locking ring bolt is embodied as peripheral grooves that are interrupted by a-web, since this promotes the shaping of the locking ring with relatively low forces, but it is also conceivable to use the locking ring with other locking ring bolts.

Preferably, the interior has a round cross section. The locking ring is thus evenly shaped in the holding geometry of the locking ring bolt during shaping of the locking ring.

In another preferred embodiment the interior has a polygonal cross section. This renders possible a further reduction of the necessary forming forces. Although the locking ring then does not surround the holding grooves quite so uniformly after conclusion of the setting process as with an interior with a round cross section, the holding forces that can be transferred are nevertheless generally more than sufficient.

Preferably, the locking ring has a round outer contour. A locking ring of this type on the one hand renders possible an esthetic overall impression, on the other hand the forming forces can be applied to the locking ring uniformly.

With another preferred embodiment the locking ring has a polygonal outer contour. The forming forces necessary for the deformation can thus be reduced. At the same time, the application of a torque on the locking ring is also facilitated, whereby the locking ring can be twisted with respect to the locking ring bolt, so that the locking ring bolt can be expanded with the aid of the web of the locking ring bolt and subsequently more easily removed.

The locking ring preferably has a first end and a second end, a peripheral flange being arranged on the second end. This flange serves on the one hand as an enlarged gripping surface on the workpiece, on the other hand, also as a limit stop for the setting tool, whereby it is discernible when the locking ring has been fully shaped.

Preferably, a chamfer is arranged on the first end. This chamfer facilitates the application of the setting tool.

In a preferred embodiment a thickening is arranged on the first end. This thickening leads to a particularly pronounced deformation of the locking ring in the area of the first end, whereby an improved positive closure of the connection over the entire locking groove area is obtained.

Preferably, at least one radially peripheral groove is arranged in the interior. This groove facilitates the formation of the locking ring and thus reduces the forming forces necessary.

Preferably, the flange has an appendage that has a smaller diameter than the flange. This appendage can penetrate into the opening of the workpiece during the setting operation, so that the locking ring is pressed into the workpiece. The locking ring is then held on the workpiece not only by the locking ring bolt, but also additionally in that the appendage is pressed into the workpiece. Overall the strength of the connection is thus increased and an additional interlocking component is inserted into the connection.

Furthermore, the bore of the workpiece can already be designed such that the appendage can be inserted into the bore to produce a fit connection.

Preferably, the locking ring has at least two notches lying opposite one another. These notches reduce the forming forces necessary for forming.

Preferably, microencapsulated adhesive and/or sealant is arranged in the holding geometry of the locking ring bolt. This adhesive or sealant is not activated until the setting process and thus increases the strength and tightness of the connection.

Preferably, microencapsulated adhesive and/or sealant is arranged in the interior of the locking ring. The strength and tightness of the connection between the locking ring and the locking ring bolt is also thus increased. Optionally, for a further improvement of the strength and tightness of the connection, the areas of the locking ring and locking ring bolt that come into contact with the workpiece or the workpieces can be provided with adhesive or sealant.

According to embodiments of the invention, a method for producing a locking ring bolt includes pressing a holding geometry into a stationary blank.

In accordance with other embodiments of the invention, the method can include separating the blank from a wire. Further, the method can include pressing a predetermined breaking point in the stationary blank, and also include pressing a bolt head on an end of the stationary blank.

In accordance with other embodiments, the pressing of the holding geometry may include pressing the stationary blank with at least a two-part mold.

The method according to embodiments of the invention can also include that pressing of the holding geometry, of the predetermined breaking point, and of the bolt head occurs one of at a same time as or after separating the blank from the wire. Moreover, the method may include shaping a point on an end of the blank opposite the bolt head.

According to further embodiments of the invention, the holding geometry may include radially peripheral grooves interrupted by at least one web running perpendicular to the grooves. Further, the pressing of the bolt head can include shaping at least one torque working surface on the bolt head.

In accordance with still other embodiments, the method may include heat treating the pressed blank.

According to embodiments of the invention, a locking ring bolt includes a shank having a holding geometry that includes radially peripheral grooves interrupted by at least one web.

In accordance with embodiments of the invention, the web can extend perpendicularly to the grooves.

According to other embodiments, a bolt head and a point can be located on opposite ends of the shank, and the grooves may be arranged over an entirety of the shank between bolt head and the point. Further, a predetermined breaking point may be located between the grooves and the point. The predetermined breaking point can have a polygonal cross-section, such as a square. Moreover, holding grooves can be located between the predetermined breaking point and the point.

According to other embodiments of the invention, the bolt head may include at least one torque working surface. Further, a transition from the bolt head to the shank can be step-shaped. Still further, a transition from the bolt head to the shank can be continuous.

In accordance with further embodiments of the invention, the grooves may have a circle segment cross-sectional shape. Also, the grooves can have a trapezoidal cross-sectional shape.

According to still other embodiments, one side of a respective groove that lies closer to the bolt head may have a shallower angle to a circumferential surface of the shank than a more distant other side of the groove.

According to other embodiments, the above-defined locking ring bolt can be in combination with a locking ring that can be arranged to surround an interior in a sleeve-shaped manner.

According to further embodiments of the invention, a fastening device includes a shank having a holding geometry that includes at least one radially peripheral groove interrupted by at least one web, and a locking ring comprising a sleeve shaped body defining an interior.

In accordance with embodiments of the invention, the interior can have a round cross-sectional shape. Also, the interior may have a polygonal cross-sectional shape.

According to embodiments, the sleeve shaped body may have a round outer contour. Also, the sleeve shaped body may have a polygonal outer contour.

In accordance with other embodiments of the invention, the locking ring can further include a first end and a second end, and a peripheral flange arranged on the second end. Moreover, the locking ring can further include a chamfer is arranged on the first end. The locking ring can also include a thickening arranged on the first end.

In accordance with embodiments, the at least one radially peripheral groove can be positionable in the interior.

According to further embodiments, the locking ring may further include an appendage arranged on the flange, such that the appendage having a smaller diameter than the flange.

According to other embodiments of the invention, the locking ring may further include at least two notches lying opposite one another.

In accordance with still yet other embodiments of the present invention, at least one of microencapsulated adhesive and sealant can be arranged in the holding geometry. Alternatively, or additionally, at least one of microencapsulated adhesive and sealant can be arranged in the interior.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 diagrammatically illustrates an exemplary representation of a method for producing a locking ring bolt according to embodiments of the invention;

FIGS. 2a and 2b illustrate a locking ring bolt according to embodiments of the invention;

FIG. 3 illustrates a locking ring bolt according to other embodiments of the invention;

FIGS. 4a-4c locking ring bold according to still other embodiments of the invention;

FIG. 5 illustrates a locking ring bolt according to further embodiments of the invention;

FIG. 6 illustrates a bolt head according to embodiments of the invention;

FIG. 7 illustrates a cross-sectional view of the bolt head depicted in FIG. 6;

FIG. 8 illustrates a bolt head according to other embodiments of the invention;

FIG. 9 illustrates a bolt head according to still other embodiments of the invention; and

FIGS. 10, 11, 12, 13, 14a, 14b, 15a, 15b, 16a, and 16b illustrate locking rings according to embodiments of the invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

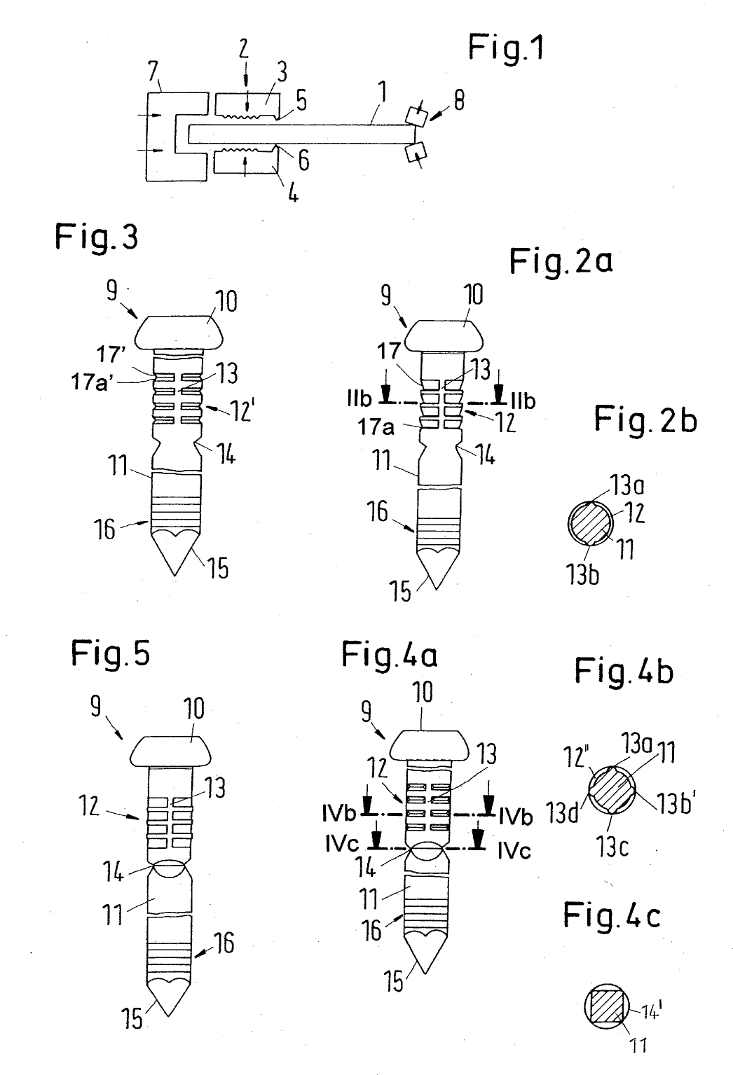

FIG. 1 shows in principle a method for producing a locking ring bolt. A blank 1 already separated from a wire is thereby shaped in several pressing tools. A two-part mold 2 with mold parts 3 and 4 is pressed laterally against blank 1 so that a holding geometry is pressed in blank 1 by the correspondingly embodied or formed surface of mold parts 3 and 4. Mold parts 3 and 4 also include a respective projection 5 and 6 to produce a predetermined breaking point in blank 1.

A bolt head can be pressed on blank 1 with the aid of a further mold 7. Furthermore, a two-part device 8 for shaping a point on blank 1 is provided. In this manner, a point is shaped on an end of blank 1 opposite the bolt head.

According to the illustrated embodiment, the press forces applied to blank 1 through the respective molds 5, 6, and 7 and through two-part device 8 are shown by arrows.

FIG. 2a shows an embodiment of a locking ring bolt 9 that has a bolt head 10 and a shank 11. Shank 11 has several peripheral grooves 12 at a predetermined distance from bolt head 10, and these grooves are interrupted by a web 13 that extends perpendicularly to grooves 12. Adjoining grooves 12, shank 11 is provided with a predetermined breaking point 14. A point 15 is shaped on the end of locking ring bolt 9 facing away from bolt head 10. Holding grooves 16 are embossed or formed between predetermined breaking point 14 and point 15 to ensure a secure hold of locking ring bolt 9 in a setting tool (not shown) during a setting operation. Grooves 12 according to this exemplary embodiment have a trapezoidal cross section, such that one side 17 of a respective groove 12 has a shallower angle to a circumferential surface of shank 11 than a more distant side 17a.

The predetermined breaking point 14 is formed by two notches.

FIG. 2b shows a cross section along lines IIa-IIa through locking ring bolt 9, as depicted in FIG. 2a. It is discernible from this figure that grooves 12 pressed into shank 11 are interrupted by two webs 13a and 13b. This locking ring bolt is therefore produced with a two-part mold.

FIG. 3 shows an embodiment of locking ring bolt 9^{I} that essentially corresponds to locking ring bolt 9 according to FIG. 2a, except that grooves 12^{I} are embossed to have a different cross section than the FIG. 2a embodiment. In this exemplary embodiment, sides 17^{I} and 17a^{I} of grooves 12 have a same angle to the circumferential surface of shank 11, and the two sides 17^{I} and 17a^{I} are arranged to meet at a base of respective grooves 12^{I} to form grooves with a triangular cross section. Moreover, it is understood that a circle segment cross-sectional groove shape is also contemplated for grooves 12^{I} without departing from the spirit and scope of the embodiments of the invention.

FIG. 4a shows an embodiment of locking ring bolt 9^{II} that corresponds essentially to the embodiment of locking ring bolt 9^{I} depicted in FIG. 3, except that locking ring bolt 9^{II} includes four webs 13a^{I}, 13b^{I}, 13,c, and 13d interrupting grooves 12^{II}. Further, locking ring bolt 9^{II} also includes a predetermined breaking point 14^{I} in shank 11 having a square cross section, as depicted in FIG. 4c.

FIG. 5 shows an embodiment of locking ring bolt 9^{III} in which a cross section of grooves 12^{III} corresponds to grooves 12 illustrated in the embodiment shown in FIG. 2a. However, locking ring bolt 9^{III} is provided with four webs corresponding to webs 13a^{I}, 13b^{I}, 13c, and 13d as depicted in FIG. 4a. In this exemplary embodiment, shank 11 has a square cross section in an area of predetermined breaking point 14^{I}, as is also depicted in FIG. 4a.

It is common to all of these locking ring bolts that they are produced by pressing from a blank 1 that initially has a uniform diameter.

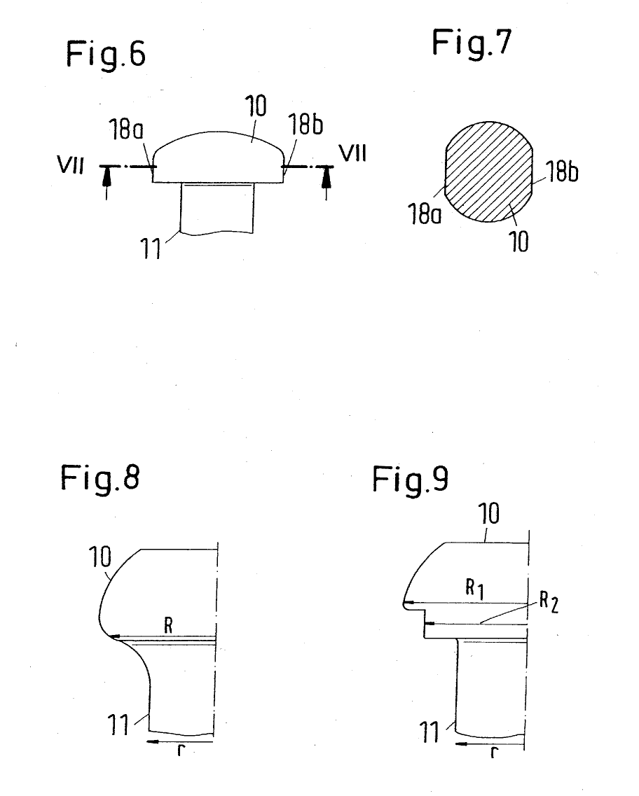

FIG. 6 shows in a detailed view a bolt head 10 that has two torque working surfaces 18a and 18b. Torque working surfaces 18a and 18b, as can be seen in particular in FIG. 7, which is a cross-sectional view of FIG. 6 taken along section line VII-VII, are embodied or formed as straight sections on bolt head 10. As shown in FIG. 6, outside of torque surfaces 18a and 18b, bolt head 10 has a round cross-section. However, it is also conceivable to provide bolt head 10 with, e.g., a hexagonal contour.

FIG. 8 shows an embodiment of a bolt head end of locking ring bolt 9, in which a transition from bolt head 10′ to shank 11 is continuous. As illustrated in the exemplary embodiment, a radius r of shank 11 continuously increases until it corresponds to a radius R of bolt head 10.

FIG. 9 shows an embodiment of a bolt head 10 end of locking ring bolt 9, in which a transition from bolt head 10^{II} to shank 11 is step-shaped. In this way, bolt head 10^{II} can have a smaller radius R₂ in an area adjacent to shank 11 than in a more distant area having a radius R₁.

The embodiments of the bolt head ends shown in FIGS. 8 and 9 are designed to evoke a slight penetration of bolt head 10^{I} or 10^{II} into the opening of a workpiece. In this manner, a press fit is obtained between bolt head 10^{I} or 10^{II} and the workpiece. It is also conceivable that the embodiment depicted in FIG. 9 can be provided with further or additional steps in the transition between bolt head 10^{II} and shank 11.

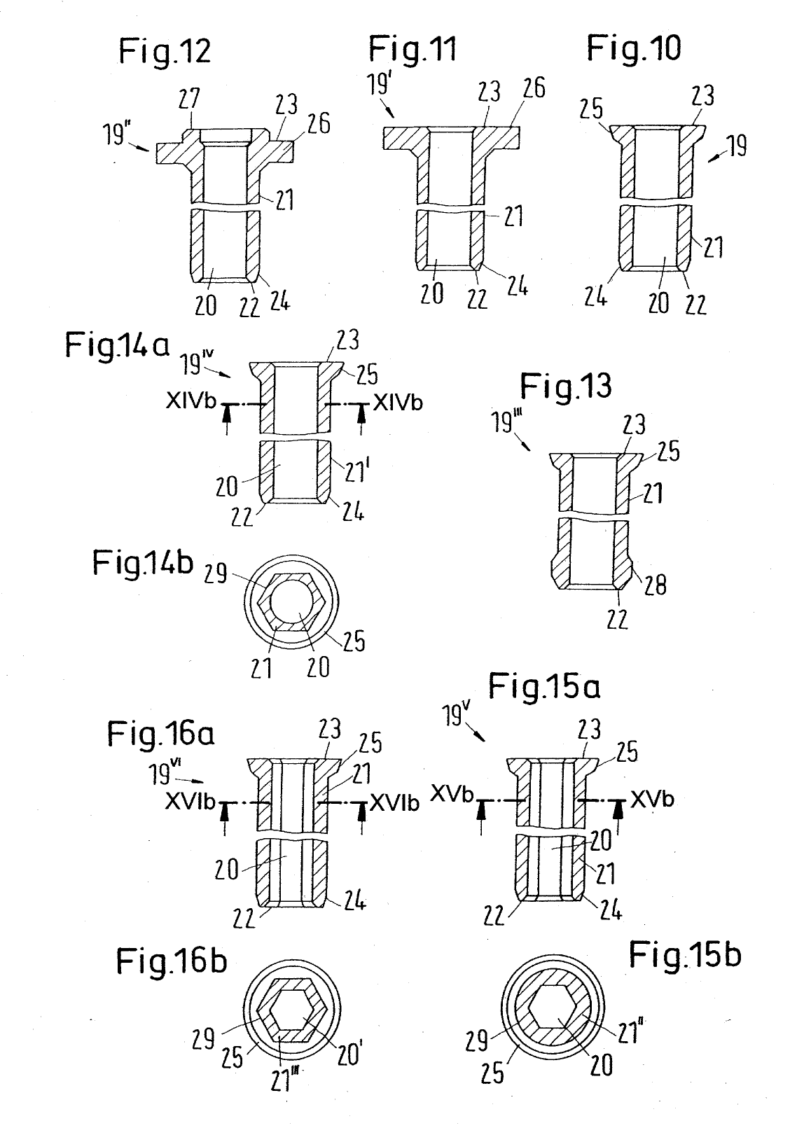

FIG. 10 shows a locking ring 19 that surrounds an interior 20 in a sleeve-shaped manner. Locking ring 19 can have a shank 21 with a first end 22 and a second end 23. A chamfer 24 is shaped on shank 21 of first end 22 for easier placement of the setting tool. A peripheral offset 25, which serves as a stop for the setting tool, is embodied or formed at second end 23. According to the illustrated embodiment, shank 11 and interior 20 have a circular cross section.

Locking ring 19^{I} according to FIG. 11 corresponds essentially to locking ring 19 depicted in FIG. 10, except that peripheral offset 25 is enlarged to form a flange 26 in order to provide a broader gripping surface for a tool.

According to FIG. 12, locking ring 19^{II} additionally has an appendage 27 on flange 26 that has a smaller diameter than flange 26. Appendage 27 is to penetrate into the opening of the workpiece during the setting of the locking ring in order to produce a press connection with the workpiece. Locking ring 19^{II} is thus held in the workpiece so that the strength of the connection of locking ring bolt, the locking ring, and workpiece is increased.

The locking ring 19^{III} according to FIG. 13 has a thickening 28 on first end 22. At a start of the setting operation, a particularly pronounced deformation of locking ring 19^{III} is thus produced.

While in the exemplary embodiments of FIGS. 10 through 13 interior 20 and shank 21 have a round cross section, shank 21^{I} of locking ring 19^{IV} according to FIG. 14a has a hexagonal outer contour 29, as shown in FIG. 14b. Interior 20 is still circular.

FIGS. 15a and 15b show a locking ring 19^{V} in which interior 20^{I} has a hexagonal cross section and shank 21^{II} has a circular outer contour 29.

FIGS. 16a and 16b show a locking ring 19^{VI} in which the interior 20^{I} has a hexagonal cross section and shank 21^{III} has a hexagonal outer contour 29.

Even though in these exemplary embodiments the cross sections of the interior or the outer contour of the shank are shown as either only round or hexagonal, it is of course also possible to embody the respective cross section as otherwise polygonal, thus for example, quadrilateral or octagonal.

Through the production of the locking ring bolt by a pressing operation, in which no intermediate heat treatment is necessary, it is possible to produce a locking ring bolt cost-effectively and quickly. It has proven thereby that sufficiently high forces can be transferred via the grooves made by pressing. The web that is formed on the contact surfaces between the individual parts of the molds and that is characteristic of the production method by pressing has also proven to be advantageous. In all, through the approach according to the embodiments of the invention a locking ring bolt system is obtained that can be produced quickly and cost-effectively and at the same time has improved holding properties. The outer contour of the locking ring can also be made by pressing.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A method for producing a locking ring bolt, comprising:
pressing a holding geometry into a stationary blank.

2. The method in accordance with claim 1, further comprising separating the blank from a wire.

3. The method in accordance with claim 2, further comprising pressing a predetermined breaking point in the stationary blank.

4. The method in accordance with claim 3, further comprising pressing a bolt head on an end of the stationary blank.

5. The method in accordance with claim 1, wherein the pressing of the holding geometry comprises pressing the stationary blank with at least a two-part mold.

6. The method in accordance with claim 4, wherein the pressing of the holding geometry, of the predetermined breaking point, and of the bolt head occurs one of at a same time as or after separating the blank from the wire.

7. The method in accordance with claim 4, further comprising shaping a point on an end of the blank opposite the bolt head.

8. The method in accordance with claim 1, wherein the holding geometry comprises radially peripheral grooves interrupted by at least one web running perpendicular to the grooves.

9. The method in accordance with claim 4, wherein the pressing of the bolt head comprises shaping at least one torque working surface on the bolt head.

10. The method in accordance with claim 1, further comprising heat treating the pressed blank.

11. A locking ring bolt comprising:
a shank having a holding geometry that includes radially peripheral grooves interrupted by at least one web.

12. The locking ring bolt in accordance with claim 11, wherein the web extends perpendicularly to the grooves.

13. The locking ring bolt in accordance with claim 11, further comprising a bolt head and a point located on opposite ends of the shank,
wherein the grooves are arranged over an entirety of the shank between bolt head and the point.

14. The locking ring bolt in accordance with claim 13, further comprising a predetermined breaking point is located between the grooves and the point.

15. The locking ring bolt in accordance with claim 14, wherein the predetermined breaking point has a polygonal cross-section.

16. The locking ring bolt in accordance with claim 15, wherein the polygonal cross-section is square.

17. The locking ring bolt in accordance with claim 15, further comprising holding grooves are located between the predetermined breaking point and the point.

18. The locking ring bolt in accordance with claim 13, wherein the bolt head has at least one torque working surface.

19. The locking ring bolt in accordance with claim 13, wherein a transition from the bolt head to the shank is step-shaped.

20. The locking ring bolt in accordance with claim 13, wherein a transition from the bolt head to the shank is continuous.

21. The locking ring bolt in accordance with claim 11, wherein the grooves have a circle segment cross-sectional shape.

22. The locking ring bolt in accordance with claim 11, wherein the grooves have a trapezoidal cross-sectional shape.

23. The locking ring bolt in accordance with claim 13, wherein one side of a respective groove that lies closer to the bolt head has a shallower angle to a circumferential surface of the shank than a more distant other side of the groove.

24. The locking ring bolt in accordance with claim 11 in combination with a locking ring, the locking ring being arranged to surround an interior in a sleeve-shaped manner.

25. A fastening device, comprising:
a shank having a holding geometry that includes at least one radially peripheral groove interrupted by at least one web; and
a locking ring comprising a sleeve shaped body defining an interior.

26. The fastening device in accordance with claim 25, wherein the interior has a round cross-sectional shape.

27. The fastening device in accordance with claim 25, wherein the interior has a polygonal cross-sectional shape.

28. The fastening device in accordance with claim 25, wherein the sleeve shaped body has a round outer contour.

29. The fastening device in accordance with claim 25, wherein the sleeve shaped body has a polygonal outer contour.

30. The fastening device in accordance with claim 25, wherein the locking ring further comprises a first end and a second end, and a peripheral flange arranged on the second end.

31. The fastening device in accordance with claim 30, wherein the locking ring further comprises a chamfer arranged on the first end.

32. The fastening device in accordance with claim 30, wherein the locking ring further comprises a thickening arranged on the first end.

33. The fastening device in accordance with claim 25, wherein the at least one radially peripheral groove is positionable in the interior.

34. The fastening device in accordance with claim 30, wherein the locking ring further comprises an appendage is arranged on the flange, the appendage having a smaller diameter than the flange.

35. The fastening device in accordance with claim 30, wherein the locking ring further comprises at least two notches lying opposite one another.

36. The fastening device in accordance with claim 25, further comprising at least one of microencapsulated adhesive and sealant being arranged in the holding geometry.

37. The fastening device in accordance with claim 25, further comprising at least one of microencapsulated adhesive and sealant being arranged in the interior.
